(19) United States
(12) Patent Application Publication
(10) Pub. No.: US 2024/0385987 A1
(43) Pub. Date: Nov. 21, 2024

(54) A computer-implemented or hardware-implemented method, a computer program product, an apparatus, a transfer function unit and a system for identification or separation of entities

(71) Applicant: IntuiCell AB, Stockholm (SE)

(72) Inventors: Henrik Jörntell, Lund (SE); Udaya Bahskar Rongala, Lund (SE)

(21) Appl. No.: 18/686,895

(22) PCT Filed: Aug. 26, 2022
(86) PCT No.: PCT/SE2022/050766

§ 371 Date: Feb. 27, 2024

(30) Foreign Application Priority Data
Sep. 3, 2021 (SE) 2151099-5

(51) Int. Cl. G06F 15/80; G06F 5/01; G06F 7/50

(52) U.S. Cl. CPC G06F 15/80; G06F 5/01; G06F 7/50

(57) ABSTRACT

The disclosure relates to a computer-implemented or hardware-implemented method (200) for identification or separation of entities, comprising: receiving (210), at a neural cell (100), a plurality of input signals (110a, 110b, . . . , 110x) from a plurality of sensors and/or from other neural cells; scaling (220), by the neural cell (100), each of the plurality of input signals (110a, 110b, . . . , 110x) with a respective weight (120a, 120b, . . . , 120x) to obtain weighted input signals (130a, 130b, . . . , 130x); calculating (230), by the neural cell (100), a sum of the weighted input signals (130a, 130b, . . . , 130x) to obtain a sum signal (140); processing (240) the sum signal (140), by a first processing unit (180) of the neural cell (100), to obtain a first additional input signal (150); amplifying (250) the sum signal (140), by an amplifier (141) of the neural cell (100), to obtain an amplified sum signal (144); adding (260), by the neural cell (100), the first additional input signal (150) to the amplified sum signal (144) to obtain an activity potential signal (170); and utilizing (270) the activity potential signal (170) as a third additional input signal to the first processing unit (180) of the neural cell (100) and as an output signal for the neural cell (100) to identify or separate entities. The disclosure further relates to a computer program product, an apparatus (300), a transfer function unit and a system for entity identification or separation.

### TECHNICAL FIELD

The present disclosure relates to a computer-implemented or hardware-implemented method for identification or separation of entities as well as to a computer program product, an apparatus, a transfer function unit and a system for entity identification or separation. More specifically, the disclosure relates to a computer-implemented or hardware-implemented method for identification or separation of entities as well as to a computer program product, an apparatus, a transfer function unit and a system for entity identification or separation as defined in the introductory parts of the independent claims.

### BACKGROUND ART

Entity identification is known from prior art. One technology utilized for performing entity identification is neural networks. One type of neural network that can be utilized for entity identification is the Hopfield network. A Hopfield network is a form of recurrent artificial neural network. Hopfield networks serve as content-addressable (“associative”) memory systems with binary threshold nodes. A model sometimes utilized for entity identification is the Hodgkin-Huxley model, which describes how action potentials in neurons are initiated and propagated. Furthermore, the FitzHugh-Nagumo model, described at http://scholarpedia.org/article/FitzHugh-Nagumo_model is a model sometimes utilized to non-linearly modify a signal. However, the FitzHugh-Nagumo model is not normally utilized for entity identification.

However, existing neural network solutions can have inferior performance and/or low reliability for certain types of problems. Furthermore, the existing solutions take a considerable time to train and therefore may require a lot of computer power and/or energy, especially for training. Moreover, existing neural network solutions may require a lot of storage space. In addition, the output of the neural network or of a neural node may not have a sufficient dynamic range or the range for the output may not be dynamically adapted/adaptable. Furthermore, a system comprising a neural network or neural nodes may be very complex. Moreover, the input sensitivity may not be adaptable/variable. In addition, simultaneous identification of several different dynamic modes in the input may not be possible.

US 2008/0258767 A1 discloses computational nodes and computational-node networks that include dynamical-nanodevice connections. Furthermore, US 2008/0258767 A1 discloses that a node comprises a state machine. However, the state machine is controlled by a global clock, thus the state of every node is dependent on the global clock and the state machine is not independent.

Therefore, there is a need for alternative approaches of entity identification or separation. Preferably, such approaches provide or enable one or more of improved performance, higher reliability, increased efficiency, faster training, use of less computer power, use of less training data, use of less storage space, less complexity, provision of a wider dynamic range, provision of a (more) adaptable dynamic range for the output, provision of a more adaptable/variable input sensitivity, identification of several different dynamic modes in the input simultaneously and/or use of less energy.

### SUMMARY

An object of the present disclosure is to mitigate, alleviate or eliminate one or more of the above-identified deficiencies and disadvantages in the prior art and solve at least the above-mentioned problem.

According to a first aspect there is provided a computer-implemented or hardware-implemented method for identification or separation of entities. The method comprises receiving, by an input unit of a neural cell, a plurality of input signals from a plurality of sensors and/or from other neural cells. Furthermore, the method comprises scaling, by scaling unit of the neural cell, each of the plurality of input signals with a respective weight to obtain weighted input signals. Moreover, the method comprises calculating, by a summing unit of the neural cell, a sum of the weighted input signals to obtain a sum signal. The method comprises processing the sum signal, by a first processing unit of the neural cell, to obtain a first additional input signal. Furthermore, the method comprises amplifying the sum signal, by an amplifier of the neural cell, to obtain an amplified sum signal. Moreover, the method comprises adding, by an addition unit of the neural cell, the first additional input signal to the amplified sum signal to obtain an activity potential signal. The method comprises utilizing, by an output unit of the neural cell, the activity potential signal as a third additional input signal to the first processing unit of the neural cell and as an output signal for the neural cell to identify or separate entities. By utilizing the activity potential signal as the output signal for the neural cell, the range of the output signal can be dynamically adapted, thereby automatically providing a wide or wider dynamic range of the output, and thereby more accurately and/or efficiently identify or separate different entities, such as phonemes.

According to some embodiments, the method comprises transforming the first additional input signal, by a second processing unit of the neural cell, to obtain a second additional input signal. According to some embodiments, the step of adding further comprises adding, by the neural cell, the second additional input signal to the amplified sum signal to obtain the activity potential signal.

According to some embodiments, processing the sum signal, by a first processing unit of the neural cell, to obtain a first additional input signal comprises: checking whether the sum signal is positive or negative; if the sum signal is negative, feeding the sum signal to a first accumulator, thereby charging the first accumulator; if the sum signal is positive or zero, feeding the sum signal to a discharge unit connected to the first accumulator; and utilizing an output of the discharge unit as the first additional input signal.

According to some embodiments, utilizing the activity potential signal as a third additional input signal to the first processing unit of the neural cell comprises: checking whether the activity potential signal is positive or negative; if the activity potential signal is negative, feeding the activity potential signal to the first accumulator, thereby charging the first accumulator; if the activity potential signal is positive or zero, feeding the activity potential signal to the discharge unit.

By implementing the neural cell (or the transfer function unit thereof) with an accumulator and a discharge unit, a highly non-linear input-output relationship which varies over time (depending on previous inputs) is achieved, thereby improving/increasing separability and/or the ability to identify an entity (e.g., as the resolution is improved). Furthermore, by implementing each neural cell (or the transfer function unit of each neural cell) of a network with an accumulator (and a discharge unit), each neural cell is provided with an intrinsic memory function (i.e., the accumulator carries cell memory properties), which is independent of other neural cell's intrinsic memories and independent of global control signals, such as global clock inputs, thus providing a more flexible system/network, which has a higher capacity to separate a higher number of entities or more accurately identifies entities. Moreover, by providing each neural cell of a network with an independent memory, the complexity of the system is reduced, e.g., since there is no need for an external clock, and/or a wider dynamic range, a greater diversity, learning with fewer resources and/or more efficient (independent) learning is achieved.

According to some embodiments, transforming the first additional input signal, by a second processing unit of the neural cell, to obtain a second additional input signal comprises: providing the first additional input signal to a second accumulator; low pass filtering an output of the second accumulator with a low pass filter to create a low-pass filtered version of the output of the second accumulator; comparing, with a comparator, the output of the second accumulator with the low-pass filtered version to create a negative difference signal; amplifying the negative difference signal with an amplifier to obtain a second additional input signal. According to some embodiments, the amplified negative difference signal is low pass or high pass filtered to obtain the second additional input signal.

According to some embodiments, the method comprises: receiving, at a compartment of the neural cell, a plurality of compartment input signals from a plurality of sensors and/or from other neural cells; scaling, by the compartment, each of the plurality of compartment input signals with a respective weight to obtain weighted compartment input signals; calculating, by the compartment, a sum of the weighted compartment input signals to obtain a compartment sum signal; processing the compartment sum signal, by a first compartment processing unit, to obtain a first additional compartment input signal; optionally transforming the first additional compartment input signal, by a second compartment processing unit, to obtain a second compartment additional input signal; amplifying the sum signal, by an amplifier of the compartment, to obtain an amplified compartment sum signal; adding, by the compartment, the first and optionally the second additional compartment input signals to the amplified compartment sum signal to obtain a compartment activity potential signal; and utilizing the compartment activity potential signal as a third additional compartment input signal to the first compartment processing unit and as a compartment output signal to adjust the sum signal based on a transfer function.

According to some embodiments, the plurality of input signals changes dynamically over time, and the activity potential signal is utilized to identify an entity, such as an object or a feature of an object, by comparing over a time period the activity potential signal to known activity potential signals associated with known entities and identifying the entity as the known entity which is associated with the known activity potential signal which is most similar to the activity potential signal.

According to some embodiments, the plurality of input signals changes dynamically over time, and the variation of the activity potential signal over time is measured by a post-processing unit, and the post-processing unit is configured to compare the measured variation to known measurable characteristics of entities, such as features of an object, comprised in a list associated with the post-processing unit and the post-processing unit is configured to identify an entity based on the comparison.

According to a second aspect there is provided a computer program product comprising a non-transitory computer readable medium, having thereon a computer program comprising program instructions, the computer program being loadable into a data processing unit and configured to cause execution of the method of the first aspect or any of the above mentioned embodiments when the computer program is run by the data processing unit.

According to a third aspect there is provided an apparatus for identification or separation of entities, comprising controlling circuitry configured to cause: reception of a plurality of input signals from a plurality of sensors and/or from other neural cells; scaling of each of the plurality of input signals with a respective weight to obtain weighted input signals; calculation of a sum of the weighted input signals to obtain a sum signal; processing of the sum signal to obtain a first additional input signal; amplification of the sum signal to obtain an amplified sum signal; optionally transformation of the first additional input signal to obtain a second additional input signal; addition of the first additional input signal, and optionally of the second additional input signal, to the amplified sum signal to obtain an activity potential signal; and utilization of the activity potential signal as a third additional input signal to a first processing unit and as an output signal to identify or separate entities.

According to some embodiments, the controlling circuitry is configured to cause processing of the sum signal, by a first processing unit of the neural cell, to obtain a first additional input signal by causing: checking of whether the sum signal is positive or negative; if the sum signal is negative, feeding of the sum signal to a first accumulator, thereby charging the first accumulator; if the sum signal is positive or zero, feeding of the sum signal to a discharge unit connected to the first accumulator; and utilization of an output of the discharge unit as the first additional input signal.

According to some embodiments, the controlling circuitry is configured to cause utilization of the activity potential signal as a third additional input signal to the first processing unit of the neural cell by causing: checking of whether the activity potential signal is positive or negative; if the activity potential signal is negative, feeding of the activity potential signal to the first accumulator, thereby charging the first accumulator; and if the activity potential signal is positive or zero, feeding of the activity potential signal to the discharge unit.

According to a fourth aspect there is provided a transfer function unit for adjusting the dynamics of a signal, the transfer function unit comprising: a reception unit configured to receive an input signal; an amplifier configured to amplify the input signal to obtain an amplified input signal; a first processing unit preferably comprising a first checking unit, the first checking unit is configured to check whether the input signal is positive or negative, configured to feed the input signal to a first accumulator if the input signal is negative and configured to feed the input signal to a discharge unit connected to the first accumulator if the input signal is positive or zero, and the first processing unit is configured to process the input signal to obtain a first additional input signal by utilizing an output of the discharge unit as the first additional input signal; an addition unit configured to add the first additional input signal to the amplified input signal to obtain an activity potential signal; and an output unit configured to provide the activity potential signal as a third additional input signal to the first processing unit and as an output signal for the neural cell, the dynamics of the output signal being different from the dynamics of the input signal.

According to some embodiments, the first processing unit comprises a second checking unit, the second checking unit is configured to check whether the activity potential signal is positive or negative; configured to feed the activity potential signal to the first accumulator if the activity potential signal is negative; and configured to feed the activity potential signal to the discharge unit if the activity potential signal is positive or zero.

According to a fifth aspect there is provided a system for identifying or separating entities comprising a plurality of neural cells. Each neural cell comprises: an input unit, configured to receive a plurality of input signals from a plurality of sensors and/or from other neural cells; a scaling unit, configured to scale each of the plurality of input signals with a respective weight to obtain weighted input signals; a summing unit, configured to calculate a sum of the weighted input signals to obtain a sum signal; and the transfer function unit of the fourth aspect. The sum signal is utilized as the input signal for the transfer function unit. The output signals of the transfer function units of the plurality of neural cells are utilized to identify or separate entities.

According to some embodiments, the first processing unit comprises a second checking unit, the second checking unit is configured to check whether the activity potential signal is positive or negative; configured to feed the activity potential signal to the first accumulator if the activity potential signal is negative; and configured to feed the activity potential signal to the discharge unit if the activity potential signal is positive or zero.

According to some embodiments, the system comprises a classifier comprising a list of known entities, such as objects, wherein each known entity is mapped to a respective (known) distribution of activity potential signals of each neural cell and the classifier is configured to receive the activity potential signal of each neural cell, configured to compare the activity potential signal of each neural cell to the distributions of activity potential signals of the known entities over a time period, and configured to identify the entity as one of the entities of the list based on the comparison.

According to some embodiments, the list is implemented as a look-up table, LUT.

According to some embodiments, the plurality of input signals changes dynamically over time and follows a sensor input trajectory.

According to some embodiments, the plurality of input signals are pixel values, such as intensity, of images captured by a camera and wherein the activity potential signal of each neural cell is further utilized to control a position of the camera by rotational and/or translational movement of the camera, thereby controlling the sensor input trajectory and wherein the entity identified is an object or a feature of an object present in one or more images of the captured images.

According to some embodiments, the plurality of sensors are touch sensors and the input from each of the plurality of sensors is a touch event signal with a force dependent value and the activity potential signal of each neural cell is utilized to identify the sensor input trajectory as a new contact event, the end of a contact event, a gesture or as an applied pressure.

According to some embodiments, each sensor of the plurality of sensors is associated with a different frequency band of an audio signal, wherein each sensor reports an energy present in the associated frequency band, and wherein the combined input from a plurality of such sensors follows a sensor input trajectory, and wherein the activity potential signal of each neural cell is utilized to identify a speaker and/or a spoken letter, a syllable, a phoneme, a word or a phrase present in the audio signal.

According to some embodiments, the plurality of sensors comprise a plurality of sensors related to a speaker, such as microphones, and wherein the output signal for the neural cell is utilized to identify or separate one or more speakers.

Effects and features of the second, third, fourth and fifth aspects are to a large extent analogous to those described above in connection with the first aspect and vice versa. Embodiments mentioned in relation to the first aspect are largely or fully compatible with the second, third, fourth and fifth aspects and vice versa.

An advantage of some embodiments is that the range of the output signal can be dynamically adapted.

Another advantage of some embodiments is that a wide or wider dynamic range of the output can be automatically provided.

Yet another advantage of some embodiments is that different entities, such as dynamic entities, e.g., phonemes, can be more accurately and/or efficiently identified or separated. A dynamic entity can exist in any sensing system, provided that it has a plurality of sensors whose activity level will differ in time from each other, when applied to the same measurement situation. A dynamic entity is here defined as a spatiotemporal pattern of activity levels across the plurality of sensors. The statistically recurring spatiotemporal patterns of sensor activity levels can correspond to a set of such dynamic entities that are useful to identify the structure of the time-evolving sensor data.

Another advantage of some embodiments is that a learning signal that is formed on basis of such dynamic entities can be present in a single node. Each node can then learn to identify a subset of dynamic entities. In a system of nodes, each node can learn to efficiently identify a potentially unique subset of entities, such as dynamic entities. A large number of nodes can then be used to identify a large number of entities, such as dynamic entities, potentially providing the system with a greater maximal performance.

An advantage of some embodiments is that a less complex system is obtained, e.g., since every component has an equivalent basic electrical/electronic component, and the entire system can be constructed using a limited set of standard electronic components.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic block diagram illustrating an example neural cell according to some embodiments;

FIG. 2 is a flowchart illustrating example method steps according to some embodiments;

FIG. 3 is a schematic block diagram illustrating an example first processing unit according to some embodiments;

FIG. 4 is a schematic block diagram illustrating an example second processing unit according to some embodiments;

FIG. 5 is a flowchart illustrating example method steps according to some embodiments;

FIG. 6 is a flowchart illustrating example method steps according to some embodiments;

FIG. 7 is a flowchart illustrating example method steps according to some embodiments;

FIG. 8 is a schematic block diagram illustrating an example neural cell according to some embodiments;

FIG. 9 is a schematic block diagram illustrating an example compartment of a neural cell according to some embodiments;

FIG. 10 is a flowchart illustrating example method steps according to some embodiments;

FIG. 11 is a schematic drawing illustrating an example computer readable medium according to some embodiments;

FIGS. 12A and 12B are flowcharts illustrating example method steps implemented in an apparatus; and

FIG. 13 is a schematic block diagram illustrating an example system according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

The term “measurable” is to be interpreted as something that can be measured or detected, i.e., is detectable. The terms “measure” and “sense” are to be interpreted as synonyms.

The term entity is to be interpreted as an entity, such as physical entity or a more abstract entity, such as a financial entity, e.g., one or more financial data sets. The term “physical entity” is to be interpreted as an entity that has physical existence, such as an object, a feature (of an object), a gesture, an applied pressure, a speaker, a spoken letter, a syllable, a phoneme, a word, or a phrase.

The term “node” or “cell” may be a neuron (of a neural network) or another processing element.

Separation refers to the process of distinguishing an entity from another entity, e.g., distinguishing a phoneme from another phoneme.

Identification refers to the process of identification, wherein a certain entity is distinguished from other entities and then classified as a known entity, e.g., by a classifier utilizing a list of known entities. Generally, the identification is a biometrics identification/authentication. One example is speaker recognition/identification, i.e., voice biometry. However, the identification may instead be image analysis, such as dynamic image analysis, e.g., inter image analysis and/or prediction, i.e., analysis and/or prediction between different (subsequent) images.

The term “time-continuous data” or “time-continuous signal” (or “continuous-time data” or “continuous-time signal”) is to be interpreted as a signal of continuous amplitude and time, such as an analog signal.

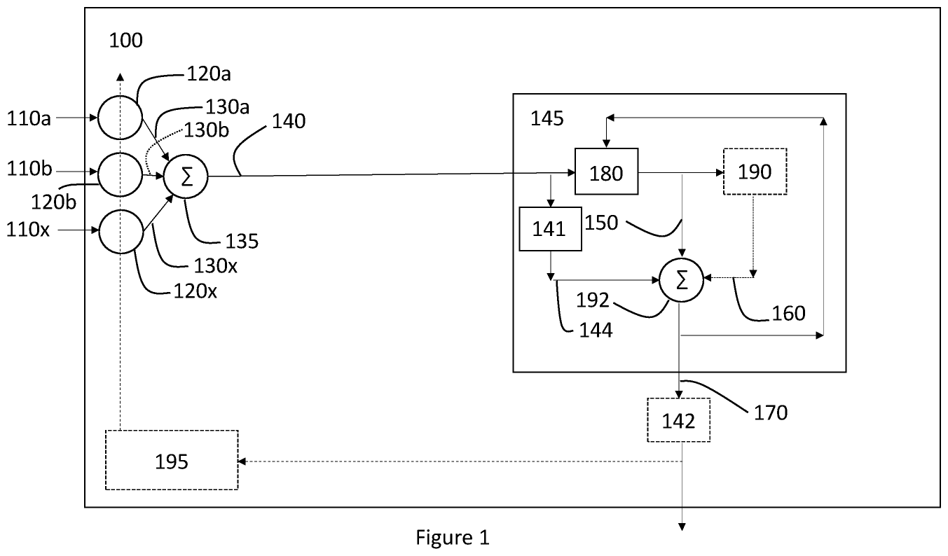

In the following, embodiments will be described where FIG. 1 is a schematic block diagram illustrating an example neural cell 100 according to some embodiments. The neural cell 100 receives a plurality of input signals 110a, 110b, . . . , 110x from a plurality of sensors (not shown). The sensors may be related to a speaker or a speech. In some embodiments, the sensors are microphones or sound detectors. Furthermore, in some embodiments the input signals 110a, 110b, . . . , 110x are each related to a specific frequency band. Moreover, in some embodiments, the frequency bands are overlapping. Alternatively, or additionally, the neural cell 100 receives a plurality of input signals 110a, 110b, . . . , 110x from other neural cells, such as output signals of other neural cells. In some embodiments, the plurality of input signals 110a, 110b, . . . , 110x changes dynamically over time and consequently follows a (sensor) input trajectory, i.e., a spatiotemporal pattern. In some embodiments, each of the plurality of input signals 110a, 110b, . . . , 110x is a time-continuous signal, such as a non-binary time-continuous signal, and sensor data is time-evolving. Alternatively, the plurality of input signals 110a, 110b, . . . , 110x are binary and/or discretized signals. The neural cell 100 scales each of the plurality of input signals 110a, 110b, . . . , 110x with a respective or corresponding weight 120a, 120b, 120x to obtain weighted input signals 130a, 130b, . . . , 130x. The neural cell 100 comprises a scaling unit (not shown) for the scaling. Furthermore, in some embodiments, the scaling is a multiplication, wherein the input signals 110a, 110b, . . . , 110x are multiplied by a respective weight 120a, 120b, . . . , 120x. The multiplication may be performed by a multiplier. The weights 120a, 120b, . . . , 120x may be determined during training and/or updated continuously. Moreover, the neural cell 100 calculates a sum of the weighted input signals 130a, 130b, . . . , 130x to obtain a sum signal 140. In some embodiments, the neural cell 100 comprises a summing unit 135 or a summer for calculating the sum. FIG. 1 also shows a transfer function unit 145, which may be part of the neural cell 100. Alternatively, the transfer function unit 145 is a stand-alone unit, which is connectable or connected to the neural cell 100. The transfer function unit 145 is for adjusting the dynamics of a signal, such as an input signal, e.g., the sum signal 140. The transfer function unit 145 comprises a reception unit (not shown) configured to receive an input signal, such as the sum signal 140. Furthermore, the transfer function unit 145 comprises an amplifier 141 configured to amplify the input signal, to obtain an amplified input signal 144. Moreover, the transfer function unit 145 comprises a first processing unit 180 configured to process the input signal to obtain a first additional input signal 150. The transfer function unit 145 comprises an addition unit 192 configured to add the first additional input signal 150 to the amplified input signal 144 to obtain an activity potential signal 170. Furthermore, the transfer function unit 145 comprises an output unit (not shown) configured to provide the activity potential signal 170 as a third additional input signal to the first processing unit 180 and as an output signal for the transfer function unit 145 and also as an output for the neural cell 100 if the transfer function unit is comprised in the neural cell 100. The transfer function unit 145 transforms the input signal, e.g., the sum signal 140, into an output signal so that the dynamics of the output signal is different from the dynamics of the input signal. Thus, the range of a signal, e.g., the sum signal 140, can be dynamically adapted, thereby automatically providing a wide or wider dynamic range of the output signal, or providing a dimensionality reduction. In some embodiments the transfer function unit 145 comprises a second processing unit 190. The second processing unit 190 is configured to transform the first additional input signal 150 to obtain a second additional input signal 160. In these embodiments, the second additional input signal 160 is added to the first additional input signal 150 and the amplified sum signal 144 to obtain the activity potential signal 170. Furthermore, in some embodiments, the neural cell 100 comprises a threshold function/unit 142. The threshold function/unit 142 adjusts the activity potential signal 170, e.g., so that the adjusted activity potential signal takes only binary values, such as 0 or 1. However, in other embodiments the threshold function/unit 142 adjusts the activity potential signal 170 based on any transfer function, such as a pure threshold function (with any output signal above the threshold value being a scalar output), or a spike generator. Furthermore, each respective weight 120a, 120b, . . . , 120x is in some embodiments updated based on a combination, such as a correlation, of the activity potential signal 170 and an input activity or a state of each respective weight 120a, 120b, . . . , 120x. The input activity of a weight may refer to the momentary/present input activity, one or more previous input activities or any combination thereof. In some embodiments, when a correlation analysis is performed, e.g. when a comparison of the activity potential signal 170 to an input activity or a state of each respective weight 120a, 120b, . . . , 120x is performed in order to calculate the correlation between the activity potential signal 170 and an input activity or a state of each respective weight 120a, 120b, . . . , 120x, the respective weights 120a, 120b, . . . , 120x are updated continuously based on the correlation. Furthermore, the activity potential signal 170 may be directly combined with or compared to the input activity for each respective weight 120a, 120b, . . . , 120x. Alternatively, the activity potential signal 170 may first be transformed, such as scaled, before the combination/comparison. Moreover, the correlation may be non-linear. In some embodiments, the learning is an unsupervised learning, such as a local unsupervised learning. Alternatively, the updating is performed by back-propagation, e.g., during training. Back-propagation may be performed by computing an overall error signal as a difference between a desired output and an actual output, distributing the overall error signal by back-propagation to the weights 120a, 120b, . . . , 120x in order to update the weights 120a, 120b, . . . , 120x and repeat this procedure until the weights 120a, 120b, . . . , 120x converge and/or until the overall error goes below an error threshold. In some embodiments, the neural cell 100 comprises an updating/learning module 195 for the updating, combining and/or correlation. In some embodiments, the updating/learning module 195 has the activity potential signal 170 directly as an input. Alternatively, the updating/learning module 195 has the output of the threshold function/unit 142 as input. In addition, the updating/learning module 195 has an input activity or a state of each respective weight 120a, 120b, . . . , 120x as another input. In some embodiments, the updating/learning module 195 produces an update signal(s), which is utilized to update each respective weight 120a, 120b, . . . , 120x.

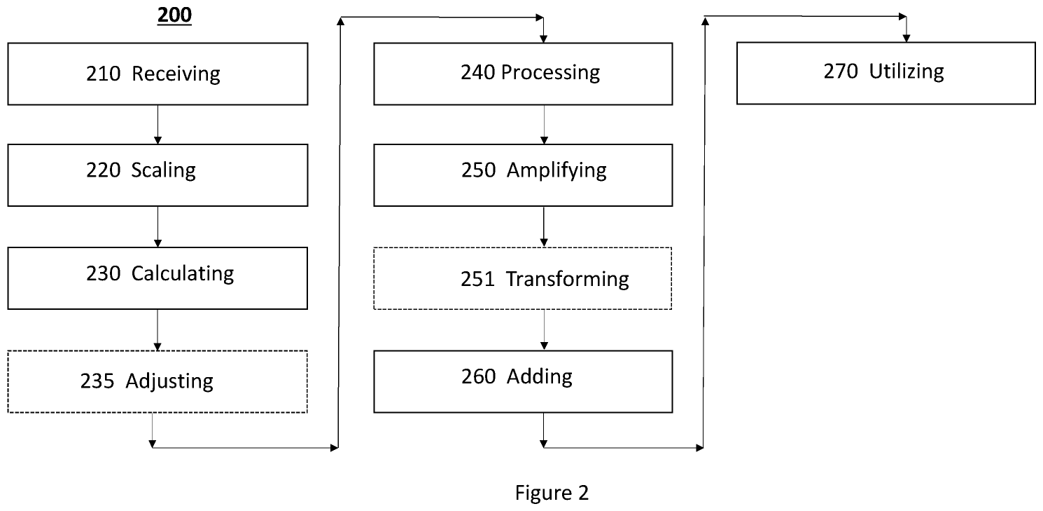

FIG. 2 is a flowchart illustrating example method steps according to some embodiments. FIG. 2 shows a computer-implemented or hardware-implemented method 200 for identification or separation of entities, such as physical entities. The method may be implemented in analog hardware/electronics circuit, in digital circuits, e.g., gates and flipflops, in mixed signal circuits, in software and in any combination thereof. The method comprises receiving 210, at a neural cell 100, a plurality of input signals 110a, 110b, . . . , 110x from a plurality of sensors and/or from other neural cells. Furthermore, the method comprises scaling 220, by the neural cell 100, each of the plurality of input signals 110a, 110b, . . . , 110x with a respective weight 120a, 120b, . . . , 120x to obtain weighted input signals 130a, 130b, . . . , 130x. Moreover, the method comprises calculating 230, by the neural cell 100, a sum of the weighted input signals 130a, 130b, . . . , 130x to obtain a sum signal 140. Optionally, the method comprises adjusting 235, by the neural cell 100, the activity potential signal 170 based on a threshold function 142 (as described above in connection with FIG. 1). The method comprises processing 240 the sum signal 140, by a first processing unit 180 of the neural cell 100, to obtain a first additional input signal 150. Furthermore, the method comprises amplifying 250 the sum signal 140, by an amplifier 141 of the neural cell 100, to obtain an amplified sum signal 144. In some embodiments, the amplifier 141 amplifies the sum signal 140 with an amplification factor having a value from 0 to 1. In other embodiments, the amplifier 141 amplifies the sum signal 140 with an amplification factor having a value from 0 to X, where X is a positive scalar value, such as 0.5, 1, 5, 10 or 100. Optionally, the method comprises transforming 251 the first additional input signal 150, by a second processing unit 190 of the neural cell 100, to obtain a second additional input signal 160. Moreover, the method comprises adding 260, by the neural cell 100, the first additional input signal 150 to the amplified sum signal 144 to obtain an activity potential signal 170. Optionally (if transforming 251 has been performed), the step of adding 260 additionally comprises adding, by the neural cell 100, the second additional input signal 160 to the amplified sum signal 144 to obtain the activity potential signal 170. The method comprises utilizing 270 the activity potential signal 170 as an extra (or third additional) input signal to the first processing unit 180 of the neural cell 100 (thereby providing a positive feedback loop, which may contribute to making a state machine within the neural cell 100 non-linear) and as an output signal for the neural cell 100 to identify or separate entities (or measurable characteristics thereof). This may be advantageous as by utilizing the activity potential signal as the output signal for the neural cell, the range of the output signal can be dynamically adapted, thereby automatically providing a wide or wider dynamic range of the output, and thereby more accurately and/or efficiently identify or separate different entities, such as phonemes. In some embodiments, e.g., if the plurality of input signals 110a, 110b, . . . , 110x changes dynamically over time, the activity potential signal (170) is utilized to identify an entity, such as an object or a feature of an object, by comparing over a time period the activity potential signal (170) to known activity potential signals associated with known entities and identifying the entity as the known entity which is associated with the known activity potential signal which is most similar to the activity potential signal (170). Alternatively, in some embodiments, e.g., if the plurality of input signals 110a, 110b, . . . , 110x changes dynamically over time, the variation of the activity potential signal 170 over time is measured by a post-processing unit. The post-processing unit is configured to compare the measured variation to known measurable characteristics of entities, such as features of an object, comprised in a list associated with (or comprised in) the post-processing unit. Furthermore, the post-processing unit is configured to identify an entity based on the comparison.

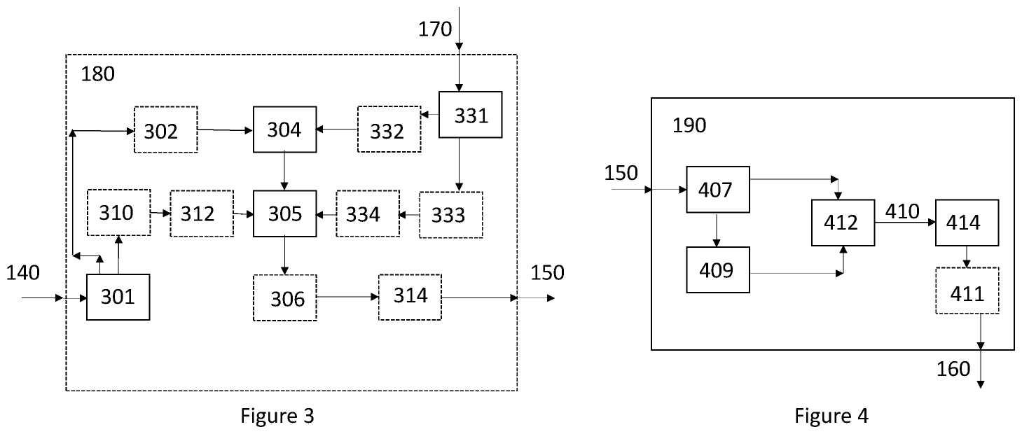

FIG. 3 is a schematic block diagram illustrating an example first processing unit 180 according to some embodiments. The first processing unit 180 processes the sum signal 140 to obtain a first additional input signal 150. In some embodiments, the first processing unit 180 is for amplifying the sum signal 140. The first processing unit 180 comprises a first checking unit 301 configured to check whether the sum signal 140 is positive or negative. Furthermore, the first processing unit 180 comprises a first accumulator 304, which receives the sum signal 140 if the sum signal 140 is negative. A negative sum signal 140 charges the first accumulator. The sum signal 140, if negative, is optionally feed through a positive clipper circuit 302 to limit the signal before reaching the first accumulator 304. Moreover, the first processing unit 180 comprises a discharge unit 305 connected to the first accumulator 304. The discharge unit 305 receives the sum signal 140 if the sum signal 140 is positive or zero. A positive or zero sum signal 140 discharges the first accumulator 304 through the discharge unit 305. The sum signal 140, if positive or zero, is optionally feed through a low pass filter 310 (RC filter) to low pass filter the signal and/or through a negative clipper circuit 312 to limit the signal. The output of the discharge unit 305 depends on the charge of the first accumulator. The output of the discharge unit 305 is utilized as the first additional input signal 150. The output of the discharge unit 305 is optionally feed through a low pass filter 306 (RC filter) to low pass filter the signal and/or a high pass filter 314 (RC filter) to high pass filter the signal before it is utilized as the first additional input signal 150. The first processing unit 180 may also receive the activity potential signal 170 as an extra input signal, e.g., a third additional input signal 170. For this purpose, the first processing unit 180 comprises a second checking unit 331 configured to check whether the extra input signal is positive or negative. The first accumulator 304 receives the extra input signal if the extra input signal is negative. A negative extra input signal charges the first accumulator. The extra input signal, if negative, is optionally feed through a positive clipper circuit 332 to limit the signal before reaching the first accumulator 304. The discharge unit 305 receives the extra input signal if the additional input signal is positive or zero. A positive or zero extra input signal discharges the first accumulator 304 through the discharge unit 305. Thus, a positive feedback loop is provided to the first processing unit 180 (e.g., from the third additional input signal 170). The extra input signal, if positive or zero, is optionally feed through a low pass filter 333 (RC filter) to low pass filter the signal and/or through a negative clipper circuit 334 to limit the signal. In some embodiments, the first accumulator 304 functions as an independent state memory.

FIG. 4 is a schematic block diagram illustrating an example second processing unit 190 according to some embodiments. The second processing unit 190 processes/transforms the first additional input signal 150 to obtain a second additional input signal 160. In some embodiments, the second processing unit 190 is for attenuating and/or oscillating the output signal, e.g., the second additional input signal 160 and thereby the activity potential signal 170. The second processing unit 190 comprises a second accumulator 407 configured to receive the first additional input signal 150. Furthermore, the second processing unit 190 comprises a low pass filter 409 configured to low pass filter an output of the second accumulator 407. Moreover, the second processing unit 190 comprises a comparator 412 configured to compare the output of the second accumulator 407 with the output of the low-pass filter 409. The second processing unit 190 comprises an amplifier 414 configured to amplify the output, e.g., a negative difference signal 410, of the comparator 412. Optionally the second processing unit 190 comprises a low pass or a high pass filter 411 configured to filter the output of the amplifier 414. The unfiltered or filtered output of the amplifier 414 is utilized as the second additional input signal 160. In some embodiments, the first and/or the second accumulator are implemented as capacitors or electrical circuits comprising one or more capacitors. Furthermore, in some embodiments, one or more of the functional blocks 301-334 (and especially 301-306, 314, 331-332) and 407-414 are implemented by standard electronics components, such as capacitors and resistors. Furthermore, in some embodiments, all the functional blocks, i.e., every component of the system, are implemented as electrical/electronic components and the entire system is constructed utilizing a limited set of standard electronic components, such as passive components, such as resistors and capacitors. Thus, complexity of the system is reduced.

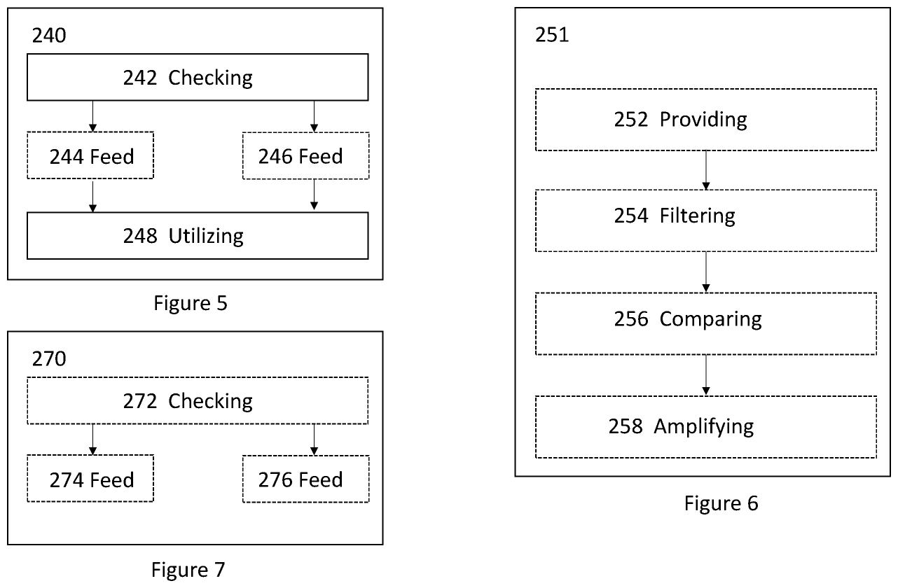

FIG. 5 illustrates that in some embodiments the step of processing 240 the sum signal 140, by a first processing unit 180 to obtain a first additional input signal 150 comprises: checking 242 whether the sum signal is positive or negative; if the sum signal 140 is negative, feeding 244 the sum signal 140 to a first accumulator 304, thereby charging the first accumulator 304; if the sum signal 140 is positive or zero, feeding 246 the sum signal 140 to a discharge unit 305 connected to the first accumulator 304, thereby discharging the first accumulator 304; and utilizing 248 an output of the discharge unit 305 as the first additional input signal 150. By implementing the neural cell (or the transfer function unit thereof) with an accumulator and a discharge unit, a highly non-linear input-output relationship which varies over time (depending on previous inputs) is achieved, thereby improving/increasing separability and/or the ability to identify an entity (as the resolution is improved). Furthermore, by implementing each neural cell (or the transfer function unit of each neural cell) of a network with an accumulator (and a discharge unit), each neural cell is provided with an intrinsic memory function, which is independent of other neural cell's intrinsic memories and independent of global control signals, such as global clock inputs, thus providing a more flexible system/network, which more accurately identifies entities. Moreover, by providing each neural cell of a network with an independent memory, the complexity of the system is reduced, e.g., since there is no need for an external clock, and/or a wider dynamic range, a greater diversity, learning with fewer resources and/or more efficient (independent) learning is achieved.

FIG. 6 illustrates that in some embodiments the step of transforming 251 the first additional input signal 150, by a second processing unit 190 of the neural cell 100, to obtain a second additional input signal 160 comprises: providing 252 the first additional input signal 150 to a second accumulator 407; low pass filtering 254 an output of the second accumulator 407 with a low pass filter 409 to create a low-pass filtered version of the output of the second accumulator 407; comparing 256, with a comparator 412, the output of the second accumulator 407 with the low-pass filtered version to create a negative difference signal 410; amplifying 258 the negative difference signal 410 with an amplifier 414, and optionally low pass or high pass filter 411 the amplified negative difference signal, to obtain a second additional input signal 160.

FIG. 7 illustrates that in some embodiments the step of utilizing 270 the activity potential signal 170 as a third additional input signal to the first processing unit 180 of the neural cell 100 comprises: checking 272 whether the activity potential signal 170 is positive or negative; if the activity potential signal 170 is negative, feeding 274 the activity potential signal 170 to the first accumulator 304, thereby charging the first accumulator 304; if the activity potential signal 170 is positive or zero, feeding 276 the activity potential signal 170 to the discharge unit 305. By implementing the neural cell (or the transfer function unit thereof) with an accumulator and a discharge unit, a highly non-linear input-output relationship which varies over time (depending on previous inputs) is achieved, thereby improving/increasing separability and/or the ability to identify an entity (as the resolution is improved). Furthermore, by implementing each neural cell (or the transfer function unit of each neural cell) of a network with an accumulator and a discharge unit, each neural cell is provided with an intrinsic memory function, which is independent of other neural cell's intrinsic memories and independent of global control signals, such as global clock inputs, thus providing a more flexible system/network, which more accurately identifies entities. Moreover, by providing each neural cell of a network with an independent memory, the complexity of the system is reduced, e.g., since there is no need for an external clock, and/or a wider dynamic range, a greater diversity, learning with fewer resources and/or more efficient (independent) learning is achieved.

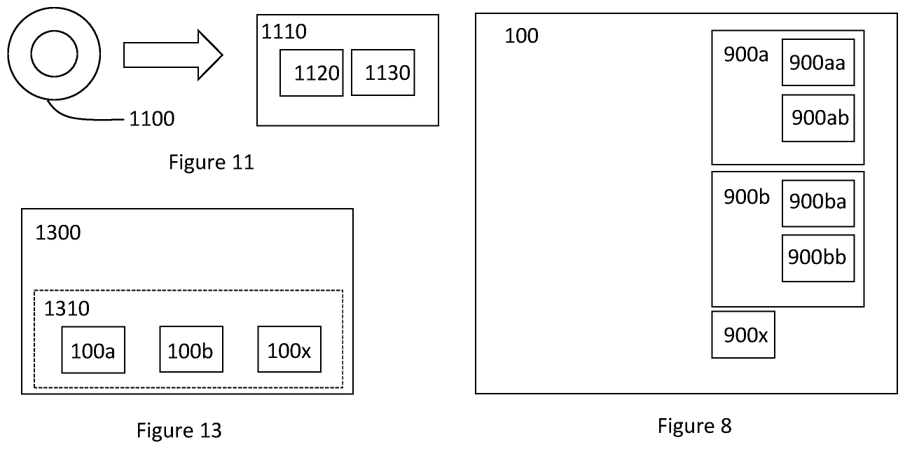

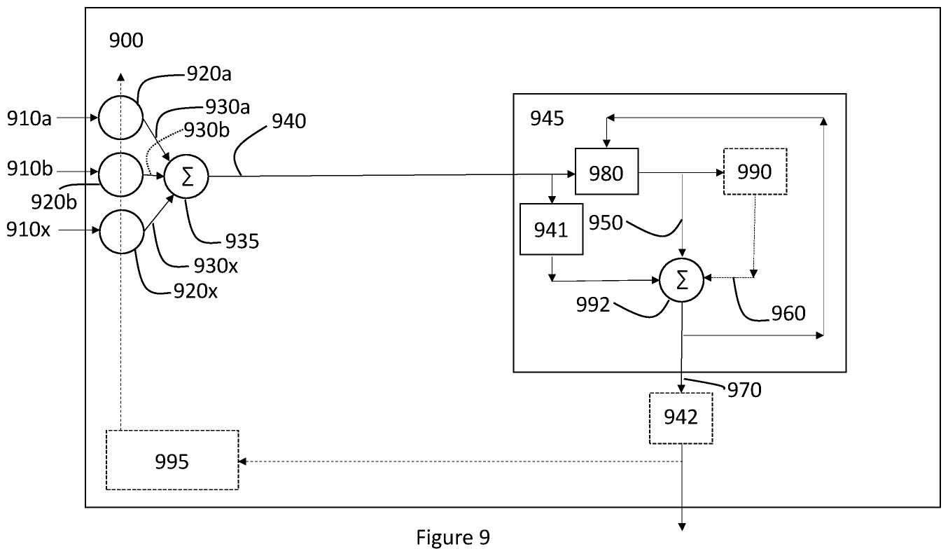

FIG. 8 is a schematic block diagram illustrating an example neural cell according to some embodiments. FIG. 8 illustrates that in some embodiments a neural cell 100 comprises compartments 900a, 900b, . . . , 900x. The compartments 900a, 900b, . . . , 900x may comprise sub-compartments 900aa, 900ab, . . . , 900ba, 900bb, . . . , 900xx. Thus, each compartment 900a, 900b, . . . , 900x may have sub-compartments 900aa, 900ab, . . . , 900ba, 900bb, sub-sub-compartments etc., which functions in the same manner as the compartments, i.e., the compartments are cascaded. For example, a sub-compartment may receive a plurality of input signals from sensors (and/or from other neural cells) and deliver a sub-compartment activity potential signal, which is utilized to adjust a compartment sum signal (of the compartment it is connected to) according to a transfer function (in analogy with the below description in connection with FIG. 9).

FIG. 9 is a schematic block diagram illustrating an example compartment of a neural cell according to some embodiments. Although below reference is made to a compartment 900 of a neural cell 100, the description in connection with FIG. 9 is also applicable to sub-compartments sub-sub-compartments etc. FIG. 9 illustrates that a compartment 900 of a neural cell 100 receives, at a compartment reception unit (not shown), a plurality of compartment input signals 910a, 910b, . . . , 910x from a plurality of sensors and/or from other neural cells and/or from other compartments. Each of the plurality of compartment input signals 910a, 910b, . . . , 910x is scaled by a scaling unit (not shown) of the compartment 900, with a respective weight 920a, 920b, . . . , 920x to obtain weighted compartment input signals 930a, 930b, . . . , 930x. A summing unit 935 of the compartment 900 calculates a sum of the weighted compartment input signals 930a, 930b, . . . , 930x to obtain a compartment sum signal 940. The compartment sum signal 940 is received at a transfer function unit 945 of the compartment 900. The transfer function unit 945 is/functions identical (ly) or similar (ly) to the transfer function unit 145 described above in connection with FIG. 1. The transfer function unit 945 comprises a reception unit (not shown), an amplifier 941, a first compartment processing unit 980, optionally a second compartment processing unit 990, an addition unit 992 and an output unit (not shown). All of the units 941, 980, 990, 992 and the reception and output units are/function identical (ly) or similar (ly) to the corresponding units for the transfer function unit 145 described in connection with FIG. 1. Furthermore, the first compartment processing unit 980 and the second compartment processing unit 990 are/function identical or similar to the first and second processing units 180, 190 described in connection with FIGS. 3 and 4 above. Furthermore, in some embodiments, the compartment 900 comprises a threshold function/unit 942. The threshold function/unit 942 adjusts the compartment activity potential signal 970, e.g., so that the adjusted activity potential signal takes only binary values, such as 0 or 1. However, in other embodiments the threshold function/unit 142 adjusts the compartment activity potential signal 970 based on any transfer function, such as a spike generator. In some embodiments, the compartment 900 comprises a compartment updating/learning module 995 for the updating, combining and/or correlation. In some embodiments, the compartment updating/learning module 995 has the compartment activity potential signal 970 directly as an input. Alternatively, the compartment updating/learning module 995 has the output of the compartment threshold function/unit 942 as input. In addition, the compartment updating/learning module 995 has an input activity or a state of each respective weight 920a, 920b, . . . , 920x as another input. In some embodiments, the compartment updating/learning module 995 produces an update signal(s), which is utilized to update each respective weight 920a, 920b, . . . , 920x. The compartment updating/learning module 995 is/functions identical or similar to the updating/learning module 195 described above in connection with FIG. 1.

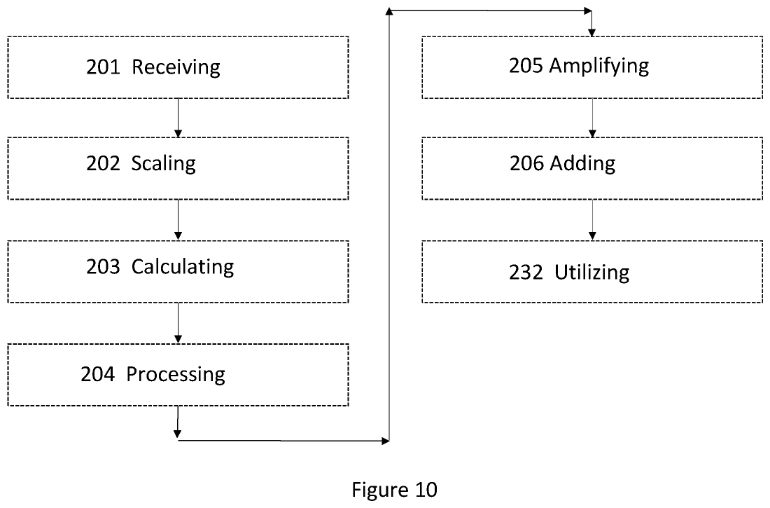

FIG. 10 is a flowchart illustrating example method steps according to some embodiments. The method steps 201, 202, 203, 204, 205, 206, 232 described below may be part of the method 200 described above in connection with FIG. 2. The method steps 201, 202, 203, 204, 205, 206, 232 may be performed before and/or in parallel with the method 200. E.g., the steps 201, 202, 203, 204, 205, 206 may be performed before the method step 210, whereas the step 232 may be performed before the method step 235 or between the method steps 230 and 235. In some embodiments, the method 200 comprises receiving 201, at a compartment 900 of the neural cell 100, a plurality of compartment input signals 910a, 910b, . . . , 910x from a plurality of sensors and/or from other neural cells. Furthermore, the method 200 may comprise scaling 202, by the compartment 900, each of the plurality of compartment input signals 910a, 910b, . . . , 910x with a respective weight 920a, 920b, . . . , 920x to obtain weighted compartment input signals 930a, 930b, . . . , 930x. Moreover, the method 200 may comprise calculating 203, by the compartment 900, a sum of the weighted compartment input signals 930a, 930b, . . . , 930x to obtain a compartment sum signal 940. The method 200 may comprise processing 204 the compartment sum signal 940, by a first compartment processing unit 980, to obtain a first additional compartment input signal 950. Optionally the method 200 comprises transforming the first additional compartment input signal 950, by a second compartment processing unit 990, to obtain a second compartment additional input signal 960. Furthermore, the method 200 may comprise amplifying 205 the compartment sum signal 940, by an amplifier 941 of the compartment 900, to obtain an amplified compartment sum signal 944. In some embodiments, the amplifier 941 amplifies the sum signal 940 with an amplification factor having a value from 0 to 1. Moreover, the method 200 may comprise adding 206, by the compartment 900, the first and optionally the second additional compartment input signals 950, 960 to the amplified compartment sum signal 940 to obtain a compartment activity potential signal 970. The method may comprise utilizing 232 the compartment activity potential signal 970 as a third additional compartment input signal to the first compartment processing unit 980 and as a compartment output signal to adjust the sum signal 140 of the neural cell 100 based on a transfer function. Examples of transfer functions that can be utilized are one or more of a time constant, such as an RC filter, a resistor, a spike generator, and an active element, such as a transistor or an op-amp. In addition to the described method steps 201, 202, 203, 204, 205, 206, 232 there may be the same or similar method steps for each of the compartments, sub-compartments etc. Each compartment, sub-compartment etc. may also be associated with a threshold function 942 and thus a method step for each compartment, sub-compartment etc. of adjusting similar or same as the adjusting step 235 may be present.

According to some embodiments, a computer program product comprises a non-transitory computer readable medium 1100 such as, for example a universal serial bus (USB) memory, a plug-in card, an embedded drive, a digital versatile disc (DVD) or a read only memory (ROM). FIG. 11 illustrates an example computer readable medium in the form of a compact disc (CD) ROM 1100. The computer readable medium has stored thereon, a computer program comprising program instructions. The computer program is loadable into a data processor (PROC) 1120, which may, for example, be comprised in a computer or a computing device 1110. When loaded into the data processing unit, the computer program may be stored in a memory (MEM) 1130 associated with or comprised in the data-processing unit. According to some embodiments, the computer program may, when loaded into and run by the data processing unit, cause execution of method steps according to, for example, one or more of the methods illustrated in FIGS. 2, 5-7 and 12, which are described herein.

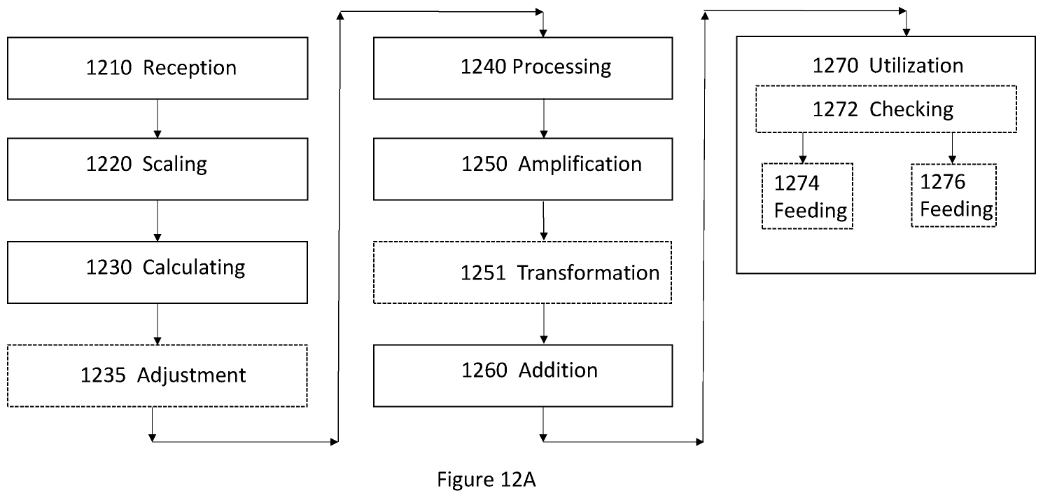

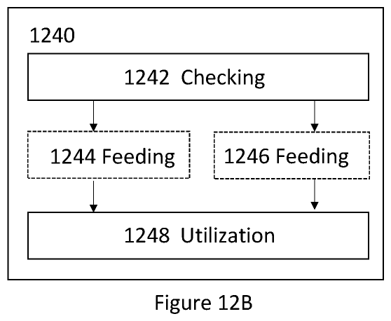

FIG. 12A and 12B are flowcharts illustrating example method steps implemented in an apparatus for identification or separation of entities. The apparatus comprises controlling circuitry. The controlling circuitry may be one or more processors. The controlling circuitry is configured to cause reception 1210, e.g., at a neural cell 100, of a plurality of input signals 110a, 110b, . . . , 110x from a plurality of sensors and/or from other neural cells. To this end, the controlling circuitry may be associated with (e.g., operatively connectable, or connected, to) a reception unit (e.g., reception circuitry or a receiver). Furthermore, the controlling circuitry is configured to cause scaling 1220, e.g., by the neural cell 100, of each of the plurality of input signals 110a, 110b, . . . , 110x with a respective weight 120a, 120b, . . . , 120x to obtain weighted input signals 130a, 130b, . . . , 130x. To this end, the controlling circuitry may be associated with (e.g., operatively connectable, or connected, to) a scaling unit (e.g., scaling circuitry or a scaler). Moreover, the controlling circuitry is configured to cause calculation 1230 of a sum of the weighted input signals 130a, 130b, . . . , 130x to obtain a sum signal 140. To this end, the controlling circuitry may be associated with (e.g., operatively connectable, or connected, to) a summing unit 135 (e.g., summing circuitry or a summer). The controlling circuitry is configured to cause processing 1240 of the sum signal 140, e.g., by a first processing unit 180, to obtain a first additional input signal 150. To this end, the controlling circuitry may be associated with (e.g., operatively connectable, or connected, to) a first processing unit 180 (e.g., processing circuitry or a processor of the neural cell 100). In some embodiments, the step of processing 1240 of the sum signal 140, by a first processing unit 180 to obtain a first additional input signal 150 comprises checking 1242 of whether the sum signal is positive or negative. If the sum signal 140 is negative, the step 1240 comprises feeding 1244 of the sum signal 140 to a first accumulator 304, thereby charging the first accumulator 304. If the sum signal 140 is positive or zero, the step 1240 comprises feeding 1246 of the sum signal 140 to a discharge unit 305 connected to the first accumulator 304, thereby discharging the first accumulator 304. Moreover, the step 1240 comprises utilization 1248 of an output of the discharge unit 305 as the first additional input signal 150. To this end, the controlling circuitry may be associated with (e.g., operatively connectable, or connected, to) a first checking unit (first checking circuitry or a first checker).

Furthermore, the controlling circuitry is configured to cause amplification 1250 of the sum signal 140 to obtain an amplified sum signal 144. To this end, the controlling circuitry may be associated with (e.g., operatively connectable, or connected, to) an amplifying unit (e.g., an amplifier 141 of the neural cell 100 or amplification circuitry). Optionally, the controlling circuitry is configured to cause transformation 1251 of the first additional input signal 150 to obtain a second additional input signal 160. To this end, the controlling circuitry may be associated with (e.g., operatively connectable, or connected, to) a second processing unit (second processing unit 190 of the neural cell 100 or a second processor). The controlling circuitry is configured to cause addition 1260 of the first additional input signal 150, and optionally the second additional input signal 160, to the amplified sum signal 144 to obtain an activity potential signal 170. To this end, the controlling circuitry may be associated with (e.g., operatively connectable, or connected, to) an addition unit 192 (an adder or addition circuitry). Furthermore, the controlling circuitry is configured to cause utilization 1270 of the activity potential signal 170 as a third additional input signal to the first processing unit 180 and as an output signal to identify or separate entities (or measurable characteristics thereof). To this end, the controlling circuitry may be associated with (e.g., operatively connectable, or connected, to) an output unit (output circuitry or output module).

Furthermore, in some embodiments, the step of utilization 1270 of the activity potential signal 170 as a third additional input signal to the first processing unit 180 of the neural cell 100 comprises checking 1272 of whether the activity potential signal 170 is positive or negative. If the activity potential signal 170 is negative, the step 1270 comprises feeding 1274 of the activity potential signal 170 to the first accumulator 304, thereby charging the first accumulator 304. If the activity potential signal 170 is positive or zero, the step 1270 comprises feeding 1276 of the activity potential signal 170 to the discharge unit 305. To this end, the controlling circuitry may be associated with (e.g., operatively connectable, or connected, to) a second checking unit (second checking circuitry or a second checker).

FIG. 13 is a schematic block diagram illustrating an example system 1300 for identifying or separating entities. The system 1300 may be or comprise a one layer neural network 1310. The system 1300 comprises a plurality of neural cells 100a, 100b, . . . , 100x. In some embodiments, each of the neural cells 100a, 100b, . . . , 100x is identical or resembles the neural cell 100 described above in connection with FIG. 1. However, in some embodiments, one or more of the functional blocks 301-334, 407-414 (described above in connection with FIGS. 3-4) have individual parameters (and therefore individual properties, which properties thus may differ between neural cells) which may differ from one neural cell (e.g., 100a) to another (e.g., 100b). By allowing one or more of the functional blocks 301-334, 407-414 to have individual parameters (and therefore individual properties), the separation or identification capacity of the system is increased, and learning is improved/made more efficient. The same advantages are achieved for compartments 900, (and sub-compartments and sub-sub-compartments etc.) as functional blocks (e.g., 980, 990) of each compartment 900 (and sub-compartments and sub-sub-compartments etc.) may have individual parameters.

Each neural cell 100a, 100b, . . . , 100x comprises: an input unit, configured to receive a plurality of input signals 110a, 110b, . . . , 110x from a plurality of sensors and/or from other neural cells; a scaling unit, configured to scale each of the plurality of input signals 110a, 110b, . . . , 110x with a respective weight 120a, 120b, . . . , 120x to obtain weighted input signals 130a, 130b, . . . , 130x; a summing unit 135, configured to calculate a sum of the weighted input signals 130a, 130b, . . . , 130x to obtain a sum signal 140. Furthermore, each neural cell 100a, 100b, . . . , 100x comprises the transfer function unit 145 described in connection with FIG. 1. Moreover, the sum signal 140 is utilized as the input signal for the transfer function unit 145. The output signal of each transfer function unit 145, i.e., the activity potential signal 170 of each neural cell 100a, 100b, . . . , 100x is optionally adjusted by a respective threshold function/unit 142. Furthermore, the output signal (or the adjusted output signal) of each transfer function unit 145, i.e., the activity potential signal 170 of each neural cell 100a, 100b, . . . , 100x together constitute a distribution of the activity potential signals 170. This distribution is utilized to identify or separate entities (or measurable characteristics thereof), e.g., by comparing the distribution to (known) distributions for different known entities. In some embodiments, the plurality of input signals 110a, 110b, . . . , 110x changes dynamically over time and consequently follows a (sensor) input trajectory, i.e., a spatiotemporal pattern. Thus, in some embodiments, each of the plurality of input signals 110a, 110b, . . . , 110x is a time-continuous signal, such as a non-binary time-continuous signal, and sensor data is time-evolving. In these embodiments, the system 1300 identifies sensory input trajectories, and the system 1300, e.g., the transfer function unit 145 thereof, adjusts/reduces the dimension of the input, e.g., the sum signal 140, to the dynamic input features, e.g., spatiotemporal patterns, present in the input signals 110a, 110b, . . . , 110x. Thus, identification/separation is greatly facilitated/improved. In some embodiments, the system 1300 further comprises a classifier connected/connectable to the activity potential signal 170 of each neural cell 100a, 100b, . . . , 100x. Such a classifier may comprise or utilize a list of known entities, such as objects. Thus, for identification and/or separation of entities, the system 1300 may comprise at least one list of (known) distributions of activity potential signals, i.e., of the activity potential signal 170 of each neural cell 100a, 100b, . . . , 100x mapped to measurable characteristics, such as features of an object or parts of different features (of objects), of the entities to be identified. In some embodiments, the classifier is configured to receive the activity potential signal 170 of each neural cell 100a, 100b, . . . , 100x. In these embodiments, the classifier is configured to compare the activity potential signal 170 of each neural cell 100a, 100b, . . . , 100x to the distributions of activity potential signals of the known entities over a time period and configured to identify the entity as one of the entities of the list based on the comparison. The list(s) may be implemented as a look-up table (LUT), and the present distribution(s) of activity potential signals may be input to the LUT to directly identify an entity, e.g., an object, such as a motorcycle, a bicycle, or a car, e.g., by directly comparing the present distribution of activity potential signals to the (known) distributions of activity potential signals of the list. In some embodiments, the distributions of activity potential signals may be directly linked to speakers, spoken letters, syllables, phonemes, words, or phrases, which can then be directly identified from a present distribution of activity potential signals.

As mentioned in connection with FIG. 3, the first accumulator 304 may function as an independent state memory. Thus, each neural cell 100a, 100b, . . . , 100x is, or comprises, in some embodiments, an independent internal state machine. Furthermore, as each internal state machine (one per neural cell 100a, 100b, . . . , 100x) is independent from the other internal state machines (and therefore an internal state machine/neural cell may have, or is capable of having, properties, such as dynamic properties, different from other internal state machines/neural cells), a wider dynamic range, a greater diversity, learning with fewer resources and/or more efficient (independent) learning is achieved. The same advantages are achieved for compartments 900, (and sub-compartments and sub-sub-compartments etc.) as each compartment 900 may have an independent internal state machine.

In some embodiments, the plurality of input signals 110a, 110b, . . . , 110x are pixel values, such as intensity or color, of images captured by a camera. If the camera moves across a visual field, then specific entities can generate specific sensor input trajectories. Statistically dominant such sensor input trajectories can be used to describe the dynamic entities existing in the visual scene, possibly as a function of the parameters of the camera movement. The entity identified is an object, such as a tree, a house, or a person, or a feature of an object, such as the distance between the eyes of a person, present in at least one image of the captured images. The system 1300 may comprise or be connected/connectable to the camera and means, such as one or more electrical motors, for rotational and/or translational movement of the camera.

In some embodiments, the plurality of sensors are touch sensors and the plurality of input signals 110a, 110b, . . . , 110x from each of the plurality of sensors are touch event signals with force dependent values, e.g., values from 0 to 1. In some embodiments, the force dependent values are compared to a threshold to create a binary value, e.g., 0 or 1, for the plurality of input signals 110a, 110b, . . . , 110x. The activity potential signal 170 of each neural cell 100 is utilized to identify the sensor input trajectory as a new contact event, the end of a contact event, a gesture or as an applied pressure. In some embodiments, each sensor of the plurality of sensors is associated with a different frequency band of an audio signal. Each sensor reports an energy present in the associated frequency band. The combined input from a plurality of the sensors follows a sensor input trajectory. The activity potential signal 170 of each neural cell 100 is utilized to identify a speaker and/or a spoken letter, syllable, phoneme, word, or phrase present in the audio signal. In some embodiments, the plurality of sensors comprise a plurality of sensors related to a speaker, such as microphones. The output signal for the neural cell 100 is utilized to identify or separate one or more speakers.

### LIST OF EXAMPLES

1. A computer-implemented or hardware-implemented method (200) for identification or separation of entities, comprising:

receiving (210), at a neural cell (100), a plurality of input signals (110a, 110b, . . . , 110x) from a plurality of sensors and/or from other neural cells;

scaling (220), by the neural cell (100), each of the plurality of input signals (110a, 110b, . . . , 110x) with a respective weight (120a, 120b, . . . , 120x) to obtain weighted input signals (130a, 130b, . . . , 130x);

calculating (230), by the neural cell (100), a sum of the weighted input signals (130a, 130b, . . . , 130x) to obtain a sum signal (140);

processing (240) the sum signal (140), by a first processing unit (180) of the neural cell (100), to obtain a first additional input signal (150);

amplifying (250) the sum signal (140), by an amplifier (141) of the neural cell (100), to obtain an amplified sum signal (144);
adding (260), by the neural cell (100), the first additional input signal (150) to the amplified sum signal (144) to obtain an activity potential signal (170); and
utilizing (270) the activity potential signal (170) as a third additional input signal to the first processing unit (180) of the neural cell (100) and as an output signal for the neural cell (100) to identify or separate entities.
2. The method of example 1, further comprising:
transforming (251) the first additional input signal (150), by a second processing unit (190) of the neural cell (100), to obtain a second additional input signal (160); and
wherein adding (260) further comprises adding, by the neural cell (100), the second additional input signal (160) to the amplified sum signal (144) to obtain the activity potential signal (170).
3. The method of any of examples 1-2, wherein processing (240) the sum signal (140), by a first processing unit (180) of the neural cell (100), to obtain a first additional input signal (150) comprises:
checking (242) whether the sum signal is positive or negative;
if the sum signal (140) is negative, feeding (244) the sum signal (140) to a first accumulator (304), thereby charging the first accumulator (304);
if the sum signal (140) is positive or zero, feeding (246) the sum signal (140) to a discharge unit (305) connected to the first accumulator (304); and
utilizing (248) an output of the discharge unit (305) as the first additional input signal (150); and/or
wherein utilizing (270) the activity potential signal (170) as a third additional input signal to the first processing unit (180) of the neural cell (100) comprises:
checking (272) whether the activity potential signal (170) is positive or negative;
if the activity potential signal (170) is negative, feeding (274) the activity potential signal (170) to the first accumulator (304), thereby charging the first accumulator (304);

if the activity potential signal (170) is positive or zero, feeding (276) the activity potential signal (170) to the discharge unit (305) and optionally

wherein transforming (251) the first additional input signal (150), by a second processing unit (190) of the neural cell (100), to obtain a second additional input signal (160) comprises:

providing (252) the first additional input signal (150) to a second accumulator (407);

low pass filtering (254) an output of the second accumulator (407) with a low pass filter (409) to create a low-pass filtered version of the output of the second accumulator (407);
comparing (256), with a comparator (412), the output of the second accumulator (407) with the low-pass filtered version to create a negative difference signal (410);
amplifying (258) the negative difference signal (410) with an amplifier (414), and optionally low pass or high pass filter (411) the amplified negative difference signal, to obtain a second additional input signal (160).
4. The method of any of examples 1-3, further comprising:
receiving (201), at a compartment (900) of the neural cell (100), a plurality of compartment input signals (910a, 910b, . . . , 910x) from a plurality of sensors and/or from other neural cells;

scaling (202), by the compartment (900), each of the plurality of compartment input signals (910a, 910b, . . . , 910x) with a respective weight (920a, 920b, . . . , 920x) to obtain weighted compartment input signals (930a, 930b, . . . , 930x);

calculating (203), by the compartment (900), a sum of the weighted compartment input signals (930a, 930b, . . . , 930x) to obtain a compartment sum signal (940);

processing (204) the compartment sum signal (940), by a first compartment processing unit (980), to obtain a first additional compartment input signal (950);

optionally transforming the first additional compartment input signal (950), by a second compartment processing unit (990), to obtain a second compartment additional input signal (960);
amplifying (205) the compartment sum signal (940), by an amplifier (941) of the compartment (900), to obtain an amplified compartment sum signal (944);
adding (206), by the compartment (900), the first and optionally the second additional compartment input signals (950, 960) to the amplified compartment sum signal (940) to obtain a compartment activity potential signal (970); and
utilizing (232) the compartment activity potential signal (970) as a third additional compartment input signal to the first compartment processing unit (980) and as a compartment output signal to adjust the sum signal (140) based on a transfer function.
5. The method of any of examples 1-4, further comprising adjusting (235), by the neural cell (100), the activity potential signal (170) based on a threshold function (142) and/or wherein each respective weight (120a, 120b, . . . , 120x) is updated based on a combination, such as a correlation, of the activity potential signal (170) and an input activity or a state of each respective weight (120a, 120b, . . . , 120x).
6. A computer program product comprising a non-transitory computer readable medium (1000), having thereon a computer program comprising program instructions, the computer program being loadable into a data processing unit (1020) and configured to cause execution of the method according to any of examples 1-5 when the computer program is run by the data processing unit (1020).
7. An apparatus for identification or separation of entities, comprising controlling circuitry configured to cause:

reception (1210) of a plurality of input signals (110a, 110b, . . . , 110x) from a plurality of sensors and/or from other neural cells;

scaling (1220) of each of the plurality of input signals (110a, 110b, . . . , 110x) with a respective weight (120a, 120b, . . . , 120x) to obtain weighted input signals (130a, 130b, . . . , 130x);

calculation (1230) of a sum of the weighted input signals (130a, 130b, . . . , 130x) to obtain a sum signal (140);

processing (1240) of the sum signal (140) to obtain a first additional input signal (150);

amplification (1250) of the sum signal (140) to obtain an amplified sum signal (144);
optionally transformation (1251) of the first additional input signal (150) to obtain a second additional input signal (160);
addition (1260) of the first additional input signal (150), and optionally of the second additional input signal (160), to the amplified sum signal (144), to obtain an activity potential signal (170); and
utilization (1270) of the activity potential signal (170) as a third additional input signal to the first processing unit (180) of the neural cell (100) and as an output signal to identify or separate entities.
8. A transfer function unit for adjusting the dynamics of a signal, the transfer function unit comprising:
a reception unit configured to receive an input signal (140);
an amplifier (141) configured to amplify the input signal (140) to obtain an amplified input signal (144);
a first processing unit (180) configured to process the input signal (140) to obtain a first additional input signal (150);
an addition unit (192) configured to add the first additional input signal (150) to the amplified input signal (144) to obtain an activity potential signal (170); and
an output unit configured to provide the activity potential signal (170) as a third additional input signal to the first processing unit (180) and as an output signal, the dynamics of the output signal being different from the dynamics of the input signal (140).
9. A system (1300) for identifying or separating entities comprising:
a plurality of neural cells (100a, 100b, . . . , 100x), each neural cell (100a, 100b, . . . , 100x) comprising: an input unit, configured to receive a plurality of input signals (110a, 110b, . . . , 110x) from a plurality of sensors and/or from other neural cells (100a, 100b, . . . , 100x);
a scaling unit, configured to scale each of the plurality of input signals (110a, 110b, . . . , 110x) with a respective weight (120a, 120b, . . . , 120x) to obtain weighted input signals (130a, 130b, . . . , 130x);
a summing unit (135), configured to calculate a sum of the weighted input signals (130a, 130b, . . . , 130x) to obtain a sum signal (140); and
the transfer function unit (145) of example 8; and
wherein the sum signal (140) is utilized as the input signal for the transfer function unit (145) and
wherein the output signals of the transfer function units (145) of the plurality of neural cells (100) are utilized to identify or separate entities.
10. The system of example 9, wherein the plurality of input signals (110a, 110b, . . . , 110x) changes dynamically over time and follows a sensor input trajectory, and
wherein the plurality of input signals (110a, 110b, . . . , 110x) are pixel values, such as intensity, of images captured by a camera and wherein the activity potential signal (170) of each neural cell (100) is further utilized to control a position of the camera by rotational and/or translational movement of the camera, thereby controlling the sensor input trajectory and wherein the entity identified is an object or a feature of an object present in one or more images of the captured images, or
wherein the plurality of sensors are touch sensors and the input from each of the plurality of sensors is a touch event signal with a force dependent value and wherein the activity potential signal (170) of each neural cell (100) is utilized to identify the sensor input trajectory as a new contact event, the end of a contact event, a gesture or as an applied pressure, or
wherein each sensor of the plurality of sensors is associated with a different frequency band of an audio signal, wherein each sensor reports an energy present in the associated frequency band, and wherein the combined input from a plurality of such sensors follows a sensor input trajectory, and wherein the activity potential signal (170) of each neural cell (100) is utilized to identify a speaker and/or a spoken letter, a syllable, a phoneme, a word or a phrase present in the audio signal or
wherein the plurality of sensors comprise a plurality of sensors related to a speaker, such as microphones, and wherein the output signal for the neural cell (100) is utilized to identify or separate one or more speakers.

The person skilled in the art realizes that the present disclosure is not limited to the preferred embodiments described above. The person skilled in the art further realizes that modifications and variations are possible within the scope of the appended claims. For example, other entities such as aroma or flavor may be identified or separated. Additionally, variations to the disclosed embodiments can be understood and effected by the skilled person in practicing the claimed disclosure, from a study of the drawings, the disclosure, and the appended claims.

1. A computer-implemented method for separation or identification of entities using a network of processing elements, each processing element of the network being independent of global control signals, the method comprising:
receiving, by an input unit of a processing element, a plurality of input signals from a plurality of sensors and optionally from other processing elements of the network of processing elements, wherein the plurality of input signals changes dynamically over time;
scaling, by a scaling unit of the processing element, each of the plurality of input signals with a respective weight to obtain weighted input signals;
calculating, by a summing unit of the processing element, a sum of the weighted input signals to obtain a sum signal;
processing the sum signal, by a first processing unit of the processing element, to obtain a first additional input signal;
amplifying the sum signal, by an amplifier of the processing element, to obtain an amplified sum signal;
adding, by an addition unit of the processing element, the first additional input signal to the amplified sum signal to obtain an activity potential signal;
utilizing, by an output unit of the processing element, the activity potential signal as a third additional input signal to the first processing unit of the processing element to provide a positive feedback loop to make a state machine within the processing element non-linear; and
utilizing, by the output unit of the processing element, the activity potential signal as an output signal for the processing element, wherein the range of the output signal of the processing element is dynamically adapted to separate or identify entities or measurable characteristics thereof.

2. The method of claim 1, further comprising:
transforming the first additional input signal, by a second processing unit of the processing element, to obtain a second additional input signal; and
wherein adding, by an addition unit of the processing element, the first additional input signal to the amplified sum signal to obtain an activity potential signal further comprises adding, by the processing element, the second additional input signal to the amplified sum signal to obtain the activity potential signal.

3. The method of claim 12, further comprising;
transforming the first additional input signal, by a second processing unit of the processing element, to obtain a second additional input signal, and
wherein the adding further comprises adding, by the processing element, the second additional input signal to the amplified sum signal to obtain the activity potential signal, wherein transforming the first additional input signal, by a second processing unit of the processing element, to obtain a second additional input signal comprises:
providing the first additional input signal to a second accumulator; low pass filtering an output of the second accumulator with a low pass filter to create a low-pass filtered version of the output of the second accumulator; comparing, with a comparator, the output of the second accumulator with the low-pass filtered version to create a negative difference signal; amplifying the negative difference signal with an amplifier, and optionally low pass or high pass filter the amplified negative difference signal, to obtain a second additional input signal.

4. The method of claim 1, further comprising:
receiving, at a compartment of the processing element, a plurality of compartment input signals from a plurality of sensors and/or from other processing elements;
scaling, by the compartment, each of the plurality of compartment input signals with a respective weight to obtain weighted compartment input signals;
calculating, by the compartment, a sum of the weighted compartment input signals to obtain a compartment sum signal;
processing the compartment sum signal, by a first compartment processing unit, to obtain a first additional compartment input signal;
optionally transforming the first additional compartment input signal, by a second compartment processing unit, to obtain a second compartment additional input signal;
amplifying the compartment sum signal, by an amplifier of the compartment, to obtain an amplified compartment sum signal;
adding, by the compartment, the first and optionally the second additional compartment input signals to the amplified compartment sum signal to obtain a compartment activity potential signal; and
utilizing the compartment activity potential signal as a third additional compartment input signal to the first compartment processing unit and as a compartment output signal to adjust the sum signal based on a transfer function.

5. The method of claim 1, further comprising adjusting, by the processing element), the activity potential signal based on a threshold function.

6. The method of claim 1, wherein each respective weight is updated based on a combination, such as a correlation, of the activity potential signal and an input activity or a state of each respective weight.

7. The method of claim 1, further comprising:
utilizing the activity potential signal to identify an entity:
comparing over a time period the activity potential signal to known activity potential signals associated with known entities; and
identifying the entity as the known entity which is associated with the known activity potential signal which is most similar to the activity potential signal.

8. The method of claim 1, wherein the variation of the activity potential signal over time is measured by a post-processing unit, wherein the post-processing unit is configured to compare the measured variation to known measurable characteristics of entities comprised in a list associated with the post-processing unit.

9. (canceled)

10. An apparatus for separation or identification of entities using a network of processing elements, each processing element of the network being independent of global control signals, the apparatus comprising controlling circuitry configured to cause, at a processing element of the network of processing elements:
reception of a plurality of input signals from a plurality of sensors and/or from other processing elements of the network of processing elements, wherein the plurality of input signals changes dynamically over time;
scaling of each of the plurality of input signals with a respective weight to obtain weighted input signals;
calculation of a sum of the weighted input signals to obtain a sum signal;
processing of the sum signal to obtain a first additional input signal;
amplification of the sum signal to obtain an amplified sum signal;
optionally transformation of the first additional input signal to obtain a second additional input signal;
addition of the first additional input signal, and optionally of the second additional input signal, to the amplified sum signal, to obtain an activity potential signal; and
utilization of the activity potential signal as a third additional input signal to the first processing unit of the processing element to provide a positive feedback loop which makes a state machine within the processing element non-linear;
utilization of the activity potential signal and as an output signal for the processing element to dynamically adapt the range of the output signal processing element to separate or identify entities or measurable characteristics thereof; and
wherein the controlling circuitry is configured to cause processing of the sum signal to obtain a first additional input signal by causing:
checking, by a first checking unit, of whether the sum signal is positive or negative;
if the sum signal is negative, feeding, by the first checking unit, of the sum signal to a first accumulator which functions as an independent state memory, thereby charging the first accumulator;
if the sum signal is positive or zero, feeding, by the first checking unit, of the sum signal to a discharge unit connected to the first accumulator to discharge the first accumulator through the discharge unit; and
utilization of an output of the discharge unit as the first additional input signal; and/or
wherein the controlling circuitry is configured to cause utilization of the activity potential signal as a third additional input signal to the first processing unit of the processing element by causing:
checking, by a second checking unit, of whether the activity potential signal is positive or negative;
if the activity potential signal is negative, feeding, by the second checking unit, of the activity potential signal to the first accumulator, thereby charging the first accumulator; and
if the activity potential signal is positive or zero, feeding, by the second checking unit, of the activity potential signal to the discharge unit to discharge the first accumulator.

11. The apparatus of claim 10, wherein at least one of the processing elements in the network of processing elements comprises a transfer function unit for adjusting the dynamics of a signal, where the transfer function unit comprises:
a reception unit configured to receive an input signal;
an amplifier configured to amplify the input signal to obtain an amplified input signal;
a first processing unit comprising a first checking unit, wherein the first checking unit is configured to check whether the input signal is positive or negative, wherein the first checking unit is configured to feed the input signal to a first accumulator if the input signal is negative and wherein the first checking unit is configured to feed the input signal to a discharge unit connected to the first accumulator if the input signal is positive or zero, and wherein the first processing unit is configured to process the input signal to obtain a first additional input signal by utilizing an output of the discharge unit as the first additional input signal;
an addition unit configured to add the first additional input signal to the amplified input signal to obtain an activity potential signal; and
an output unit configured to provide the activity potential signal as a third additional input signal to the first processing unit and as an output signal, the dynamics of the output signal being different from the dynamics of the input signal.

12. The apparatus of claim 10, wherein at least one of the processing elements in the network of processing elements comprises a transfer function unit for adjusting the dynamics of a signal, where the transfer function unit comprises:
a reception unit configured to receive an input signal;
an amplifier configured to amplify the input signal to obtain an amplified input signal;
a first processing unit comprising a first checking unit, wherein the first checking unit is configured to check whether the input signal is positive or negative, wherein the first checking unit is configured to feed the input signal to a first accumulator if the input signal is negative and wherein the first checking unit is configured to feed the input signal to a discharge unit connected to the first accumulator if the input signal is positive or zero, and wherein the first processing unit is configured to process the input signal to obtain a first additional input signal by utilizing an output of the discharge unit as the first additional input signal;
an addition unit configured to add the first additional input signal to the amplified input signal to obtain an activity potential signal; and
an output unit configured to provide the activity potential signal as a third additional input signal to the first processing unit and as an output signal, the dynamics of the output signal being different from the dynamics of the input signal; and
wherein the first processing unit further comprises a second checking unit, wherein the second checking unit is configured to check whether the activity potential signal is positive or negative; wherein the second checking unit is configured to feed the activity potential signal to the first accumulator if the activity potential signal is negative, and wherein the second checking unit is configured to feed the activity potential signal to the discharge unit if the activity potential signal is positive or zero.

13. A system for separating or identifying entities using a network of processing elements, each processing element of the network being independent of global control signals, the system comprising:
a plurality of processing elements, each processing element having an independent memory and comprising:
an input unit, configured to receive a plurality of input signals from a plurality of sensors and/or from other processing elements;
a scaling unit, configured to scale each of the plurality of input signals with a respective weight to obtain weighted input signals;
a summing unit, configured to calculate a sum of the weighted input signals to obtain a sum signal; and
a transfer function unit for adjusting the dynamics of a signal, the transfer function unit comprising:
a reception unit configured to receive an input signal;
an amplifier configured to amplify the input signal to obtain an amplified input signal;
a first processing unit comprising a first checking unit, wherein the first checking unit is configured to check whether the input signal is positive or negative, wherein the first checking unit is configured to feed the input signal to a first accumulator if the input signal is negative and wherein the first checking unit is configured to feed the input signal to a discharge unit connected to the first accumulator if the input signal is positive or zero, and wherein the first processing unit is configured to process the input signal to obtain a first additional input signal by utilizing an output of the discharge unit as the first additional input signal;
an addition unit configured to add the first additional input signal to the amplified input signal to obtain an activity potential signal; and
an output unit configured to provide the activity potential signal as a third additional input signal to the first processing unit and as an output signal, the dynamics of the output signal being different from the dynamics of the input signal; and
wherein the sum signal is utilized as the input signal for the transfer function unit and
wherein the output signals of the transfer function units of the plurality of processing elements are utilized to separate or identify entities.

14. The system of claim 13, wherein the first processing unit further comprises a second checking unit wherein the second checking unit is configured to check whether the activity potential signal is positive or negative; wherein the second checking unit is configured to feed the activity potential signal to the first accumulator if the activity potential signal is negative, and wherein the second checking unit is configured to feed the activity potential signal to the discharge unit if the activity potential signal is positive or zero.

15. The system of claim 13, further comprising a classifier comprising a list of known entities, such as objects, wherein each known entity is mapped to a respective distribution of activity potential signals of each processing element and wherein the classifier is configured to receive the activity potential signal of each processing element wherein the classifier is configured to compare the activity potential signal of each processing element to the distributions of activity potential signals of the known entities over a time period, and configured to identify the entity as one of the entities of the list based on the comparison.

16. (canceled)

17. The system of claim 13, wherein the plurality of input signals changes dynamically over time and follows a sensor input trajectory, and wherein the plurality of input signals comprises pixel values, such as intensity, of images captured by a camera and wherein the activity potential signal of each processing element is further utilized to control a position of the camera by rotational and/or translational movement of the camera, thereby controlling the sensor input trajectory and wherein the entity identified is an object or a feature of an object present in one or more images of the captured images.

18. The system of claim 13, wherein the plurality of input signals changes dynamically over time and follows a sensor input trajectory, and wherein the plurality of sensors are touch sensors and the input from each of the plurality of sensors comprises a touch event signal with a force dependent value and wherein the activity potential signal of each processing element is utilized to identify the sensor input trajectory as a new contact event, the end of a contact event, a gesture or as an applied pressure.

19. The system of claim 13, wherein the plurality of input signals changes dynamically over time and follows a sensor input trajectory, and wherein each sensor of the plurality of sensors is associated with a different frequency band of an audio signal, wherein each sensor reports an energy present in the associated frequency band, and wherein the combined input from the plurality of sensors follows a sensor input trajectory, and wherein the activity potential signal of each processing element is utilized to identify a speaker and/or a spoken letter, a syllable, a phoneme, a word or a phrase present in the audio signal.

20. The system of claim 13, wherein the plurality of input signals changes dynamically over time and follows a sensor input trajectory, and wherein the plurality of sensors comprise a plurality of sensors related to a speaker, such as microphones, and wherein the output signal for the processing element is utilized to separate or identify one or more speakers.

21. The method of claim 1, wherein processing the sum signal, by a first processing unit of the processing element, to obtain a first additional input signal comprises:
checking, by a first checking unit, whether the sum signal is positive or negative;
if the sum signal is negative, feeding, by the first checking unit, the sum signal to a first accumulator which functions as an independent state memory, thereby charging the first accumulator;
if the sum signal is positive or zero, feeding, by the first checking unit, the sum signal to a discharge unit connected to the first accumulator to discharge the first accumulator through the discharge unit; and
wherein utilizing the activity potential signal as a third additional input signal to the first processing unit of the processing element comprises:
checking, by a second checking unit, whether the activity potential signal is positive or negative;
if the activity potential signal is negative, feeding, by the second checking unit, the activity potential signal to the first accumulator, thereby charging the first accumulator; and
if the activity potential signal is positive or zero, feeding, by the second checking unit, the activity potential signal to the discharge unit to discharge the first accumulator.

22. The method of claim 1, wherein the method is implemented at least partially in hardware.

23. method of claim 1, wherein processing the sum signal, by a first processing unit of the processing element, to obtain a first additional input signal comprises:
checking, by a first checking unit, whether the sum signal is positive or negative;
if the sum signal is negative, feeding, by the first checking unit, the sum signal to a first accumulator which functions as an independent state memory, thereby charging the first accumulator;
if the sum signal is positive or zero, feeding, by the first checking unit, the sum signal to a discharge unit connected to the first accumulator to discharge the first accumulator through the discharge unit;
utilizing an output of the discharge unit as the first additional input signal; and
utilizing the activity potential signal as a third additional input signal to the first processing unit of the processing element, wherein the positive feedback loop is formed by:
checking, by a second checking unit, whether the activity potential signal is positive or negative;
if the activity potential signal is negative, feeding, by the second checking unit, the activity potential signal to the first accumulator, thereby charging the first accumulator; and
if the activity potential signal is positive or zero, feeding, by the second checking unit, the activity potential signal to the discharge unit to discharge the first accumulator.

24. The method of claim 1, wherein the variation of the activity potential signal over time is measured by a post-processing unit, wherein the post-processing unit is configured to compare the measured variation to known measurable characteristics of entities comprised in a list associated with the post-processing unit, and wherein the post-processing unit is configured to identify an entity based on the comparison.

25. The method of claim 1, wherein each processing element of the network has a global network clock independent memory.
